(19) United States
(12) Patent Application Publication
(10) Pub. No.: US 2017/0093974 A1
(43) Pub. Date: Mar. 30, 2017

(54) SYSTEM FOR DOWNLOAD OF MEDIA FOR A WIRELESS ENABLED PICTURE FRAME

(71) Applicant: Rajeev Gupta, Great Neck, NY (US)

(72) Inventor: Rajeev Gupta, Great Neck, NY (US)

(21) Appl. No.: 14/220,053

(22) Filed: Sep. 24, 2015

(51) Int. Cl. H04L 29/08; H04W 84/12

(52) U.S. Cl. CPC H04L 67/1097; H04W 84/12; H04L 67/02

(57) ABSTRACT

The present invention provides a device that enables an output device to display data found and retrieved through a wireless portal from a source. More specifically, a digital picture frame that itself does not contain the internal architecture for wireless connectivity is connectable to a wireless enabling device that then enables the digital picture frame to connect to a wireless portal and retrieve data in a known specific wireless location or from a non-specifically known wireless location.

### FIELD OF THE INVENTION

The present invention provides a device that enables an output device to display data found and retrieved through a wireless portal from a source. More specifically, a digital picture frame that itself does not contain the internal architecture for wireless connectivity is connectable to a wireless enabling device that then enables the digital picture frame to connect to a wireless portal and retrieve data in a known specific wireless location or from a non-specifically known wireless location.

### BACKGROUND

The last twenty five years has witnessed amazing advancement. Whole industries have been created whose sole objective is in the creation of and manipulation of digitized information. Such digitized information finds its home on the Internet and specifically on computers and servers attached to the Internet.

Whole industries have also been lost in the rush to create and use digitized information. For example, the film industry which once had its place in former corporate giants like Eastman Kodak, has all but ceased to exist. In its place are digital cameras, smartphones, digital tablets, digital picture frames, and the like, that either take pictures and digitize them or display such digitized images.

In displaying digitized images, digital picture frames have been created that can be loaded with such images. Usual loading involves either connecting, by hard wire, a digital picture frame to a digital image source (i.e., a computer, server and the like). Another way to load images onto a digital picture frame is by use of a portable drive, like a flash drive, that can be connected to a digital picture source noted hereinabove and then hand carried to the digital picture frame for loading of the digital images thereon.

Such a usual process of digital picture display is fraught with human error. First, such digital picture frames are not themselves updateable automatically. Second, hard wire connections are often inconvenient and difficult to maintain. Additionally, flash drives can be lost, broken, or worse, contain viruses that impair a digital picture frame, computer or both.

What is needed therefore is a process of transferring digitized images and/or music files from a data file source to an output device like a digital picture frame that avoids the traps of physical and/or wired digitized data transfers. Especially for non-wireless enabled devices (i.e., non-wireless enabled picture frames), a wireless solution is needed that avoids a direct physical connection to a computer/server, reduces the possibility of infection by virus resident on a digital picture frame or flash memory device, allows for user directed updates from a wireless location, enables a more efficient use of resources, and provides greater user control of a change of pictures.

The above problems and more are solved by the embodiments provided herein and will be discussed in much greater detail hereinbelow.

### SUMMARY

Accordingly, the invention herein provides a process for retrieval and display of content from a source. The process comprises all of the following steps:

a. Providing a wireless enabled device, the wireless enabled device having at least one processor, memory, a transmission device for wireless connection, and a software program stored within the memory;

b. Providing an output device;

c. Connecting the wireless enabled device physically to the output device;

d. Operating the at least one processor by instructions provided by the software program;

e. Connecting said wireless enabled device to a wireless gateway through said transmission device operable by said software program;

f. Establishing a wireless connection to the source through the wireless gateway;

g. Providing a web-based application on the source;

h. Sending a command from the software to the processor;

i. Connecting the wireless enabled device to the web-based application by the command;

j. Providing a user interface on the web-based application, the user interface receiving instructions from a user;

k. Inputting a location of specified data into the web-based application, the web-based application communicating the location of the specified data to the wireless enabled device;

l. Retrieving the specified data for download by the wireless enabled device to the output device; and

m. Displaying the specified data on the output device.

An output device is provided to which the wireless enabled device is physically connected. Exemplary output devices herein include, but are not limited to electronic picture frames, laptop computers, desktop computers, electronic tablets and nearly any electronic device that contains either a memory card slot or USB port for connection to the wireless enabled device herein. Preferably, the wireless enabled device herein connects to all known, standard memory slots or USB ports found worldwide in electronic devices of the type mentioned herein.

In use, the wireless enabled device physically connects to the output device. Also, the wireless enabled device operates a software program thereon (and perhaps more than one) by its processor. Preferably, the software program is written onto the memory of the wireless enabled device; the software program is also preferably multi-functional with as many sub-routines necessary to operate all of the functions required for use of the wireless enabled device.

The software program provides several important, key functions. It connects the wireless enabled device to a wireless gateway through the transmission device. By such connection, the output device to which the wireless enabled device is connected also connects to the wireless gateway. The wireless output device is then able to connected to a wireless source (e.g., the Internet, a computer/server, or other device like a smart phone).

Another important function of the wireless enabled device herein is to find specified data in a specified location. This is done typically, but not exclusively, by sending a command from the web-based application to the wireless enabled device to find the specified data; retrieve the specified data for download by the wireless enabled device to the output device; and then display the specified data on the output device, such data being displayable by viewing, hearing or both. Also, the wireless enabled device gives instructions to said output device for the storage of said specified data onto said output device.

In another embodiment herein, the wireless enabled device herein can be programmed to 1) find non-specified data in a non-specified location or 2) to find specified data in a non-specified location. In the first condition, a user may request, through a software interface on the web-based application, for the wireless enabled device to search for data (e.g., a picture of a gorilla) on the Internet, but not in a specific data file attached thereto. Upon finding such data, a user may then choose from a selection, if offered, or from one match provided. Upon such choosing, the data is downloaded by the wireless enabled device to the output device. In the second condition, the wireless enabled device can be programmed to perform a search for data in a non-specified location (e.g., a specific data file on a website). This would be useful where a user knows that a picture exists on one or more websites but does not know exactly where to tell the wireless enabled device to look other than ‘on the Internet’.

Regardless of what kind of data is sought or where it is sought, the wireless enabled device may be programmed to look for and/or retrieve such data at prescribed times with prescribed downloads thereof—such times being weekly, daily or hourly. Also, the output device may be likewise programmed (i.e., by receipt of instructions from the wireless enable device or from software on the output device itself) to display the data at prescribed times and in a prescribed manner—such times being weekly, daily or hourly.

In one embodiment herein, the established wireless connection is severed upon completed retrieval of the specified data. In another embodiment here, the wireless connection is maintained for a pre-set amount of time after the specified data is retrieved by the wireless enabled device.

In practice, the appropriate output device is one in that is not wirelessly enabled without the wireless enabled device. Also, where present, the software on the wireless enabled device, on a smart device and/or the web-based application operate collaboratively for the search, retrieval, storage and display of data. For example, where the user has a user device (e.g., a smart phone), the user device may have an application that connects the user device directly to the web-based application. In use, the user device communicates with the wireless enabled device through the web-based application. The application provides instructions to the wireless enabled device for its operation.

In another embodiment herein, a wireless enabled device for connecting a non-wireless enabled device to a wireless portal is provided. The wireless enabled device comprises all of the following:

a. At least one connection point on the non-wireless enabled device;

b. At least one matching connection point on the wireless enabled device whereby the wireless enabled device is physically connectable to the non-wireless enabled device;

c. Memory positioned within that wireless enabled device;

d. At least one processor positioned within the wireless enabled device;

e. A transmission device for wireless connection positioned within the wireless enabled device;

f. Software for connecting the transmission device of the wireless enabled device to a wireless gateway stored within the memory;

g. Software within the memory, the software locating content stored on a source; and

h. Software for retrieving the content stored on the source.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 provides a flow diagram of the signature processes of the system herein;

FIG. 2 provides a flow diagram of the details of process 400 of system herein; and

FIG. 3 provides a flow diagram of the details of process 500 of the system herein.

### DETAILED DESCRIPTION

By the term “media” it is meant herein all forms of digital information that may be displayed and/or listened to on an electronic device including, but not limited to, digital information having file extensions ending with .GIF, .JPEG, .TIFF, .PNG, .BMP, .MOV, .MPEG, .AVI, .FLV, .MP4, .MXF, .WAV, .MP3, .AIFF, .AU and .PCM. It is expressly noted herein that the particular extension of a file herein is not part of the invention herein. It is sufficient to know, however, that the invention is designed to handle all kinds of viewable and hearable media.

By the term “display” or “output display” or “wireless display device” it is meant herein either visual display, auditory display or both. That is, an output device herein has the ability to display images, play audio or both. Typical output displays contemplated herein are digital picture frames, pad devices, flat televisions and digital audio devices.

By the term “wireless enabled device” it is meant a device that can enable another device, to which the wireless enabled device is attached, to access a wireless network thereby connecting to the Internet or to an intranet. Wireless enabled devices of the kind contemplated herein are wireless SD cards, wireless USB devices and wireless memory cards.

By the term “processor” or “computer processor” it is meant herein a central processing unit, also referred to as a central processor unit, is the hard are within a computer that carries out the instructions of a computer program by performing the basic arithmetical, logical, and input/output operations of the system.

By the term “web application” it is t herein a web-based application that uses a web browser located on the Internet or an intranet as a client.

By the term “wireless gateway” it is meant herein a computer networking device that routes packets from a wireless local area network (LAN) to another network, typically a wired wide area network (WAN).

Accordingly, the invention herein provides a process for retrieval and display of content from a source. The process comprises all of the following steps:

a. Providing a wireless enabled device, the wireless enabled device having at least one processor, memory, a transmission device for wireless connection, and a software program stored within the memory;

b. Providing an output device;

c. Connecting the wireless enabled device physically to the output device;

d. Operating the at least one processor by instructions provided by the software program;

e. Connecting said wireless enabled device to a wireless gateway through said transmission device operable by said software program;

f. Establishing a wireless connection to the source through the wireless gateway;

g. Providing a web-based application on the source;

h. Sending a command from the software to the processor;

i. Connecting the wireless enabled device to the web-based application by the command;

j. Providing a user interface on the web-based application, the user interface receiving instructions from a user;

k. Inputting a location of specified data into the web-based application, the web-based application communicating the location of the specified data to the wireless enabled device;

l. Retrieving the specified data for download by the wireless enabled device to the output device; and

m. Displaying the specified data on the output device.

An output device is provided to which the wireless enabled device is physically connected. Exemplary output devices herein include, but are not limited to electronic picture frames, laptop computers, desktop computers, electronic tablets and nearly any electronic device that contains either a memory card slot or USB port for connection to the wireless enabled device herein. Preferably, the wireless enabled device herein connects to all known, standard memory slots or USB ports found worldwide in electronic devices of the type mentioned herein.

In use, the wireless enabled device physically connects to the output device. Also, the wireless enabled device operates a software program thereon (and perhaps more than one) by its processor. Preferably, the software program is written onto the memory of the wireless enabled device; the software program is also preferably multi-functional with as many sub-routines necessary to operate all of the functions required for use of the wireless enabled device.

The software program provides several important, key functions. It connects the wireless enabled device to a wireless gateway through the transmission device. By such connection, the output device to which the wireless enabled device is connected also connects to the wireless gateway. The wireless output device is then able to connected to a wireless source (e.g., the Internet, a computer/server, or other device like a smart phone).

Another important function of the wireless enabled device herein is to find specified data in a specified location. This is done typically, but not exclusively, by sending a command from the web-based application to the wireless enabled device to find the specified data; retrieve the specified data for download by the wireless enabled device to the output device; and then display the specified data on the output device, such data being displayable by viewing, hearing or both. Also, the wireless enabled device gives instructions to said output device for the storage of said specified data onto said output device.

In another embodiment herein, the wireless enabled device herein can be programmed to 1) find non-specified data in a non-specified location or 2) to find specified data in a non-specified location. In the first condition, a user may request, through a software interface on the web-based application, for the wireless enabled device to search for data (e.g., a picture of a gorilla) on the Internet, but not in a specific data file attached thereto. Upon finding such data, a user may then choose from a selection, if offered, or from one match provided. Upon such choosing, the data is downloaded by the wireless enabled device to the output device. In the second condition, the wireless enabled device can be programmed to perform a search for data in a non-specified location (e.g., a specific data file on a website). This would be useful where a user knows that a picture exists on one or more websites but does not know exactly where to tell the wireless enabled device to look other than ‘on the Internet’.

Regardless of what kind of data is sought or where it is sought, the wireless enabled device may be programmed to look for and/or retrieve such data at prescribed times with prescribed downloads thereof—such times being weekly, daily or hourly. Also, the output device may be likewise programmed (i.e., by receipt of instructions from the wireless enable device or from software on the output device itself) to display the data at prescribed times and in a prescribed manner—such times being weekly, daily or hourly.

In one embodiment herein, the established wireless connection is severed upon completed retrieval of the specified data. In another embodiment here, the wireless connection is maintained for a pre-set amount of time after the specified data is retrieved by the wireless enabled device.

In practice, the appropriate output device is one in that is not wirelessly enabled without the wireless enabled device. Also, where present, the software on the wireless enabled device, on a smart device and/or the web-based application operate collaboratively for the search, retrieval, storage and display of data. For example, where the user has a user device (e.g., a smart phone), the user device may have an application that connects the user device directly to the web-based application. In use, the user device communicates with the wireless enabled device through the web-based application. The application provides instructions to the wireless enabled device for its operation.

In another embodiment herein, a wireless enabled device for connecting a non-wireless enabled device to a wireless portal is provided. The wireless enabled device comprises all of the following:

i. At least one connection point on the non-wireless enabled device;

j. At least one matching connection point on the wireless enabled device whereby the wireless enabled device is physically connectable to the non-wireless enabled device;

k. Memory positioned within that wireless enabled device;

l. At least one processor positioned within the wireless enabled device;

m. A transmission device for wireless connection positioned within the wireless enabled device;

n. Software for connecting the transmission device of the wireless enabled device to a wireless gateway stored within the memory;

o. Software within the memory, the software locating content stored on a source; and

p. Software for retrieving the content stored on the source.

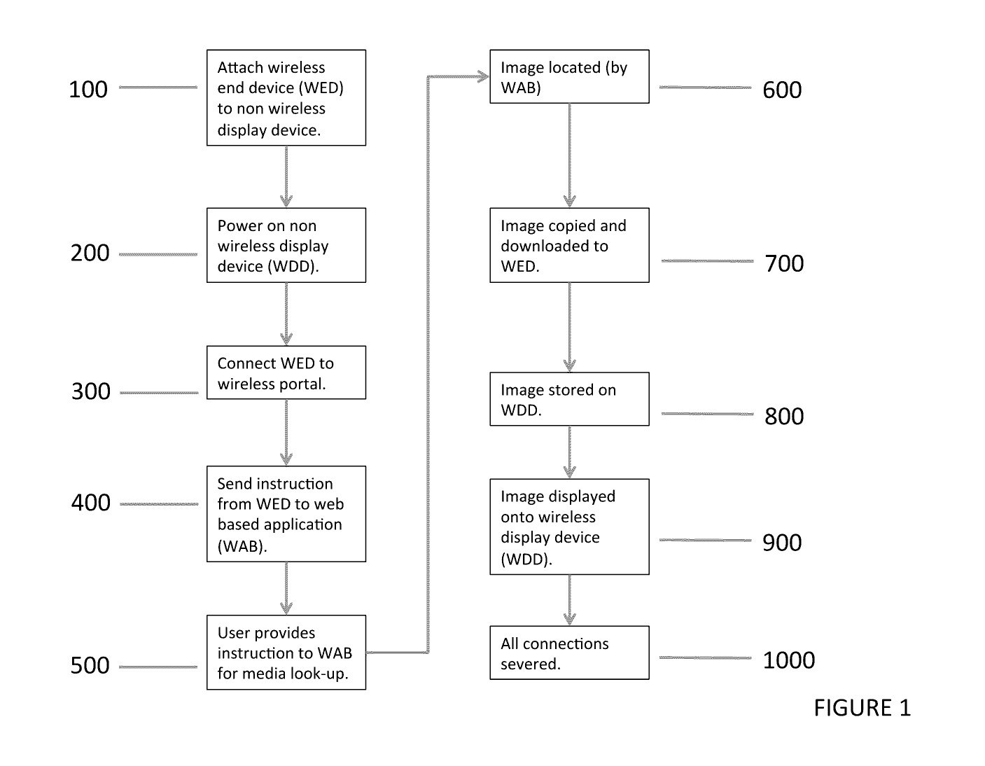

FIG. 1 provides a flow chart of the process described herein. Specifically, FIG. 1 provides all major interactions between the wireless enabled device, web application, media retrieval, and picture display. In the first step, 100, to enabling the system, a wireless end device (WED) is attached to an output device, preferably being a digital picture frame. Importantly, the WED serves as the conduit for network connectivity for the display device herein, that does not itself contain the architecture for wireless connectivity. That is, the preferred display device merely plays media received by outside source through another device; i.e., the WED.

Next, step 200 shows the display device being powered ‘on’, which powering enables the display device and the WED connected thereto. Once powered on, software loaded onto the memory of the WED will be triggered by the processor within the WED to search for and attach to a WAN or LAN—step 300. If such WAN or LAN are password restricted, a prompt on the display device will appear. A user can then submit the appropriate password, where necessary, thereby enabling the WED to connect to the WAN or LAN.

By such step 300, the WED can then send information and instructions to a web-based application—step 400. The web-based application and the WED are configured to communicate optimally with one-another whereby information is smoothly and effortlessly transmitted therebetween and instructions relayed as well.

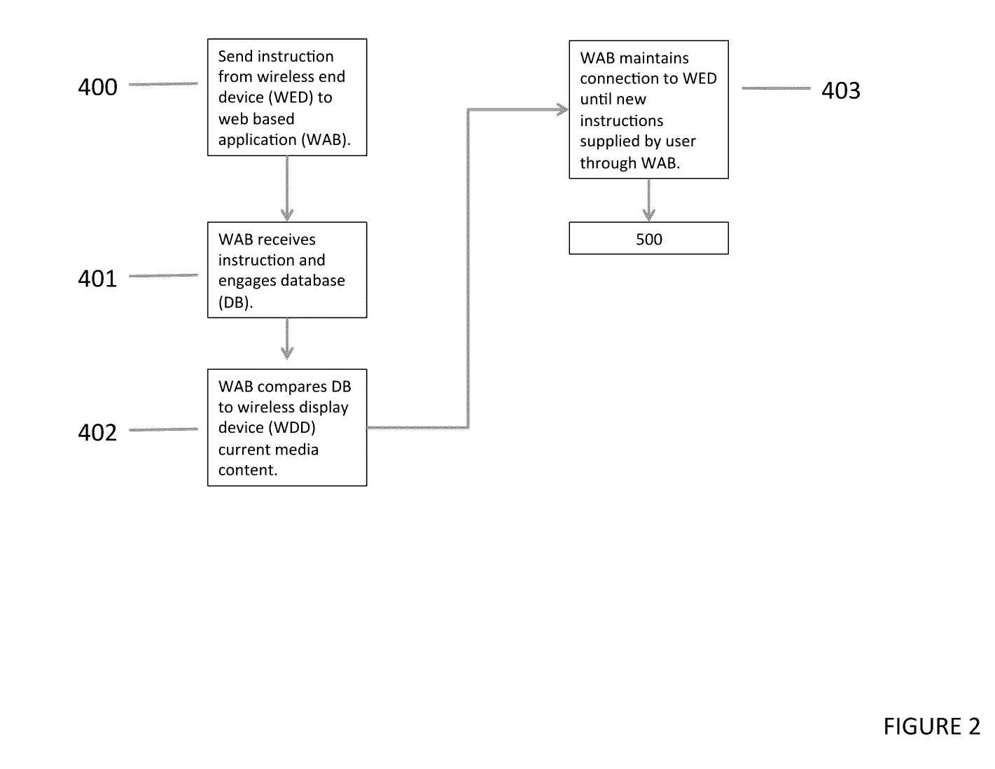

Step 400 is a multi-functional step, which steps are shown in FIG. 2. Step 401 provides that the web-based application (WBA) receives an instruction to engage a database (DB). By the term “database” it is meant herein a digital file that contains one or more types of media as detailed hereinabove. Ideally, access to the database is configured to occur only through the WBA thereby limiting opportunities to corrupt the data therein or for unscrupulous persons to infiltrate the database by digital means.

Step 402 provides that the WBA connect to the wireless end device (WED). At such connection, the WBA then establishes a link to a media database. There may be more than one media databases. By the term “media database(s)” is meant herein one or more web-based, server based or computer based digital file locations that contain one or more media file types that are accessible by the wireless end device, the web-based application or both. Once a link to a media database is established, step 403 requires that the WBA compare the media located within the media database to that which is resident within the wireless display device (WDD). Upon such comparison, a query is made to a User via the WBA requesting what, if any, new media should be acquired from the media database and then downloaded to the WDD. Also queried to a User is whether existing media resident within the WDD should be removed. In step 404, the WAB maintains its connection to the WED until the User supplies new instructions by user through the WBA.

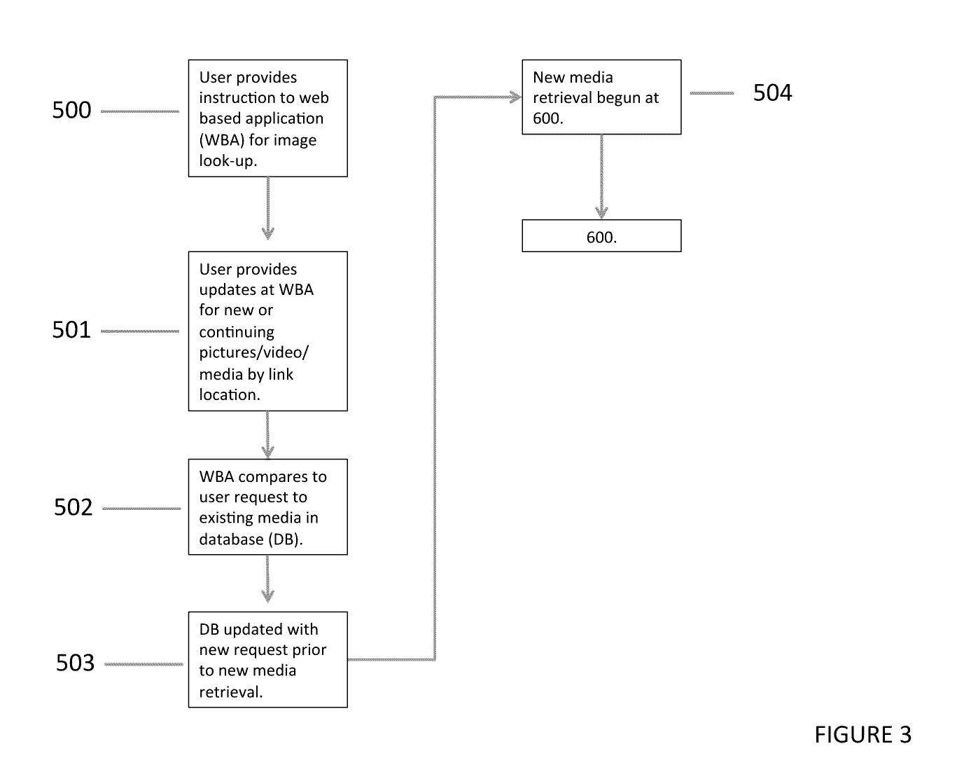

In step 500, the User answers the query (FIG. 3). Specifically, the User provides instruction to web-based application (WBA) for media acquisition from the media database. The User, at step 501, provides updates at the WBA for new or continuing pictures/video/media for download to the wireless display device (WDD). In step 502, the WBA reviews the comparison of the User's request to existing media in the WDD and the media database.

Step 503 provides that the media database is updated with every new request from a User for a new media download. In step 504, requested new media selected is retrieved from he media database and concludes at step 600. By the term “retrieved”, it is meant herein that the media is copied from the media database and that the copy thereof is downloaded from the media database by the wireless end device and stored onto the wireless display device (WDD) in place of the previous media stored on the WDD.

Digital picture frames of the type contemplated herein are those known by persons of skill in the art that play media like digital images, music and/or video and that have the capacity to have a an SD card, USB device or memory device attached thereto.

In another embodiment herein, the wireless enabled device herein can be programmed to 1) find non-specified data in a non-specified location or 2) to find specified data in a non-specified location. In the first condition, a user may request, through a software interface, for the wireless enabled device to search for data (e.g., a picture of a gorilla) on the Internet, but not in a specific data file attached thereto. Upon finding such data, a user may then choose from a selection, if offered, or from one match provided. Upon such choosing, the data is downloaded by the wireless enabled device to the output device. In the second condition, the wireless enabled device can be programmed to perform a search for data in a non-specified location (e.g., a specific data file on a website). This would be useful where a user knows that a picture exists on one or more websites, but said user does not know exactly where to tell the wireless enabled device to look other than ‘on the Internet’.

Regardless of what kind of data is sought or where it is sought, the wireless enabled device may be programmed to look for and/or retrieve such data at prescribed times with prescribed downloads thereof—such times being weekly, daily or hourly. Also, the output device may be likewise programmed (i.e., by receipt of instructions from the wireless enable device or from software on the output device itself) to display the data at prescribed times and in a prescribed manner—such times being weekly, daily or hourly.

In one embodiment herein, the established wireless connection is severed upon completed retrieval of the specified data. In another embodiment here, the wireless connection is maintained for a pre-set amount of time after the specified data is retrieved by the wireless enabled device.

The wireless enabled device may also be programmed to give instructions to the output device for the storage of the specified data onto the output device. Also, the output device may itself comprise software that enables communication with the wireless enabled device. The output device's software, when provided, directs the wireless enabled device to perform its functions like connecting to a wireless portal, finding a specific data file in a specific place or perform a search for a particular type of data in a known or unknown wireless location.

In a preferred embodiment herein, the system comprises a user device like a smart phone or other easily hand held electronic device that is connected or readily connectable to the Internet. The user device comprises software that enables its communication with the wireless enabled device. Similar to that of the output device when it contains software as noted hereinabove, the user device's software provides directions to the wireless enabled device for is operation.

In practice, the appropriate output device is one in that is not wirelessly enabled without the wireless enabled device. Also, where present, the software on the wireless enabled device and the software on the output device operate collaboratively for the search, retrieval, storage and display of data.

Also provided is a wireless enabled device for connecting a non-wireless enabled device to a wireless portal. The wireless enabled device comprises at least one connection point. At least one matching connection point resides on the wireless enabled device that is physically connectable to the non-wireless enabled device. A preferred connection mechanism for the wireless enabled device and the output device is a USB port type of connecting mechanism.

The wireless enabled device also contains memory. Further, at least one processor is positioned within the wireless enabled device. A transmission device for a wireless connection is positioned within the wireless enabled device. Software for connecting the transmission device of the wireless enabled device to a wireless portal is stored within the memory, as well as, software for locating content stored on a wireless source. Lastly, software for retrieving content stored on the wireless source is located within memory of the wireless enabled device. Preferably, the wireless enabled device comprises software for directing the storage of the content onto the non wireless enabled device.

As has been noted herein above, the preferred wireless enabled device is an SD card. In use, the SD card connects a device, e.g., an electronic picture frame, to a wireless port for access to data in a wireless location or to an electronic file on a computer/server that is itself connected to a wireless portal. It is important to note herein that preferred use of the SD card herein is for a device that does not contain the internal electronic architecture to itself connect to a wireless portal. As has been noted herein, many electronic picture frames are constructed that do not contain this architecture. Their usual mode of picture addition is by physical transfer of digital files thereto via a pre-loaded memory device or by direct physical connection to a computer/server that contains such digital files. This method of addition of digital picture files is inefficient, slow and potentially subjects all used electronic devices to debilitating and costly viruses.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A process for retrieval and display of content from a source, comprising:
a. Providing a wireless enabled device, said wireless enabled device having at least one processor, memory, a transmission device for wireless connection, and a software program stored within said memory;
b. Providing an output device;
c. Connecting said wireless enabled device physically to said output device;
d. Operating said at least one processor by instructions provided by said software program;
e. Connecting said wireless enabled device to a wireless gateway through said transmission device operable by said software program;
f. Establishing a wireless connection to said source through said wireless gateway;
g. Providing a web-based application on said source;
h. Sending a command from said software to said processor;
i. Connecting said wireless enabled device to said web-based application by said command;
j. Providing a user interface on said web-based application, said user interface receiving instructions from a user;
k. Inputting a location of specified data into said web-based application, said web-based application communicating said location of said specified data to said wireless enabled device;

l. Retrieving said specified data for download by said wireless enabled device to said output device; and
m. Displaying said specified data on said output device.

2. The process of claim 1 in which said specified data is displayed by viewing.

2. The process of claim 1 whereby said specified data is displayed by hearing.

3. The process of claim 1 in which said specified data is displayed by viewing and hearing.

4. The process of claim 1 whereby said wireless enabled device gives instructions to said output device for the storage of said specified data onto said output device.

5. The process of claim 1 comprising a user device, said user device having an application, said application connecting directly to said web-based application.

6. The process of claim 6 wherein said application on said user device communicates with said wireless enabled device through said web-based application, said application providing instructions to said wireless enabled device for operation.

7. The process of claim 1 wherein said wireless enabled device retrieves specified data from a pre-scribed location on a pre-scribed schedule.

8. The process of claim 8 wherein said pre-scribed schedule is weekly.

9. The process of claim 8 wherein said pre-scribed schedule is daily.

10. The process of claim 8 wherein said pre-scribed schedule is hourly.

11. The process of claim 1 wherein said output device is not wirelessly enabled without said wireless enabled device.

12. A process for retrieval and display of content from a source, comprising:
a. Providing a wireless enabled device, said wireless enabled device having at least one processor, memory, a transmission device for wireless connection, and a software program stored into said memory;
b. Providing an output device;
c. Connecting said wireless enabled device physically to said output device;
d. Operating said at least one processor by instructions from said software program on said wireless enabled device;
e. Connecting said wireless enabled device to a wireless gateway through said transmission device operable by said software program;
f. Establishing a wireless connection to said source through said wireless gateway;
g. Providing a web-based application on said source;
h. Sending a command from said software to said processor;
i. Connecting said wireless enabled device to said web-based application by said command;
j. Providing a user interface on said web-based application, said user interface receiving instructions from a user;
k. Inputting a query for data into said web-based application, said web-based application communicating said query for said data to said wireless enabled device;

l. Finding a location of said data on said source;
m. Retrieving said data for download by said wireless enabled device to said output device; and
n. Displaying said data on said output device.

13. The process of claim 12 in which said specified data is displayed by viewing.

14. The process of claim 12 in which said specified data is displayed by hearing.

15. The process of claim 12 whereby said wireless enabled device gives instructions to said output device for the storage of said specified data onto said output device.

16. The process of claim 12 comprising a user device, said user device having an application, said application connecting directly to said web-based application.

17. The process of claim 17 wherein said application on said user device communicates with said wireless enabled device through said web-based application, said application providing instructions to said wireless enabled device for operation.

18. The process of claim 12 wherein said wireless enabled device retrieves specified data from a pre-scribed location on a pre-scribed schedule.

19. A system for retrieval and display of content from a source, comprising:
a. An output device;
b. A wireless enabled device, having at least one processor, memory, a transmission device for wireless connection, and a software program stored into said memory; and
c. A connection whereby said wireless enabled device is physically connectable to said output device;
Said software program directing said transmission device to establish a connection to a wireless gateway and thereby connecting to a source.

20. A wireless enabled device for connecting a non-wireless enabled device to a wireless portal, comprising:
a. At least one connection point on said non-wireless enabled device;
b. At least one matching connection point on said wireless enabled device whereby said wireless enabled device is physically connectable to said non-wireless enabled device;
c. Memory positioned within said wireless enabled device;
d. At least one processor positioned within said wireless enabled device;
e. A transmission device for wireless connection positioned within said wireless enabled device;
f. Software for connecting said transmission device of said wireless enabled device to a wireless gateway stored within said memory;
g. Software within said memory, said software locating content stored on a source; and
h. Software for retrieving said content stored on said source.
